(19) United States
(12) Patent Application Publication
(10) Pub. No.: US 2009/0039101 A1
(43) Pub. Date: Feb. 12, 2009

(54) Browsing and vending system

(76) Inventor: Nicholas Alcov, Arroyo Grande, CA (US)

Correspondence Address: Nicholas Alcov, 2398 Callender Rd., Arroyo Grande, CA, 93420, US

(21) Appl. No.: 11/449,879

(22) Filed: Jun. 9, 2006

(51) Int. Cl. A47F 3/02; G06K 7/00

(52) U.S. Cl. 221/155; 235/440

(57) ABSTRACT

A portable sign system utilizing lights and sounds to enhance the message or image displayed of signs provided with the system or pre-existing signs and increase their usefulness beyond daylight hours. The sign system provides an adjustable frame capable of accommodating a plurality of sign dimensions. The adjustable frame is capable of housing the lights utilized to illuminate and enhance the sign as well as accommodate the source of auditory enhancement. A means of attachment and a means of providing power which is appropriate to the location in which the sign will be utilized is provided.

In another embodiment the portable sign system affixes the lights, means of power, means of attachment, means of auditory enhancement, directly to the sign without the use of a frame.

### FIELD OF THE INVENTION

The present invention generally relates to signs, and more particularly to a sign system which enhances the message or image displayed of the signs provided with the system, as well as enhancing pre-existing signs through lights and sounds.

### BACKGROUND OF THE INVENTION

Signs have been relied upon to provide information as well as enhance the appeal of products and thus increase sales. These signs range from inexpensive paper signs to elaborate expensive displays. Typically most inexpensive signs are only useful during daylight hours. In addition these signs are so similar that they loose their desired affect.

Signs utilizing neon or other light sources are an attempt to overcome the problem of only being useful during daylight hours and the drabness of non lighted signs. The draw back to these are that they are expensive and only one message is displayed. Elaborate computer lighted displays are expensive and they are not portable.

Signs which are portable and capable of illuminating a display are available for example, U.S. Pat. No. 6,154,994 discusses a rectangular plastic housing which supports a transparent plastic face plate which carries a message illuminated by a florescent light source behind the sign. This sign may be affixed to a window. Although the patent addresses the issues of portability and illumination, it does not address the multitude of pre-existing signs which lack these features.

None of the prior arts particularly discuss the means which enable a user to enhance the pre-existing signs through the use of light and sound in an inexpensive manner.

Accordingly, there is a need for a means by which a user can purchase a sign which is portable and draw attention to it, thus providing an advantage over other signs with which it must compete for the attention of its audience. In addition there is a need for a sign system which will enhance pre-exiting signs through the use of light and sound in an inexpensive manner and extend the usefulness beyond daylight hours.

### SUMMARY OF THE INVENTION

In view of the foregoing disadvantages of the prior arts, the general purpose of the present invention is to provide a sign and a sign system, to include the advantages of the prior art, and to overcome the drawbacks inherent therein.

In one aspect, the present invention provides an adjustable sign frame system which can accommodate most plastic pre-printed signs relating to cars. This sign frame system includes a means by which lights flash, dim, get illuminated in a sequential manner so as to imply direction, have various hues, change the hues seen and/or the like. The sign frame system has a means of attachment and/or a stand and power sources suitable for but not limited to motor vehicles.

In one aspect, the present invention provides an adjustable sign frame system which can accommodate most plastic pre-printed signs relating to, but not limited to the home or business. This sign frame system attracts attention by means of lights which flash, get illuminated in a sequential manner so as to imply direction, pulsate, have hues of various colors. change the hues seen and/or the like. The sign frame system has a means of attachment to a surface and/or a stand and power source suitable for but not limited to a home or business.

In another aspect, the present invention provides a sign frame system which can expand or contract to accommodate most pre-printed signs. The sign frame system has lights which draw attention by means such as flashing, getting illuminated in a sequential manner so as to imply direction, dimming, having various hues, changing the hues seen and/or the like The sign frame system has a means of attachment to a surface and/or a stand and a means of providing power. In addition the sign frame system contains a speaker with a means of emitting various sounds, music, pre-recorded information and/or the like to draw attention of the curious.

In another aspect, the present invention provides an adjustable sign frame system which can accommodate most pre-printed signs as well as portions of the frame which can rotate thus accommodating polygon shaped signs and fold for a more compact package. In addition the sign frame system has a means by which lights flash, get illuminated in a sequential manner so as to imply direction, dim, have various hues, change the hues seen and/or the like. The sign frame system has a means of attachment and a power source. In addition the sign frame system contains a speaker and/or a micro-recorder capable of providing a pre-recorded message, have music and other such means to draw attention.

In yet another aspect, the present invention provides a sign frame system which can adjust to accommodate the parameter of pre-printed signs as well as a means to accommodate the thickness of the signs. The sign frame system has lights which flash, dim, pulsate, get illuminated in a sequential manner so as to imply direction have various hues, change the hues seen, and/or the like. The sign frame system has a means of attachment and/or stand and its own power sources including but not limited to battery and solar as well as means to receive power through ac adapter, car cigarette lighter, and/or the like.

In yet another aspect, the present invention provides a sign frame system which includes pre-printed signs, an adjustable sign frame which accommodate these signs as well as many pre-printed signs as sold in stationary stores, hardware stores and the like. The sign frame system has lights which flash, dim, pulsate, get illuminated in a sequential manner so as to imply direction have various hues, change the hues seen and/or the like. The sign frame system has means of attachment and/or stand and a power source. The sign frame system has an option to enhance the sign by means for sounds, music, micro-recording of information and/or the like. The pre-printed signs will be made of plastic or other suitable material. Packages which include the sign frame and signs appropriate or relating to motor vehicles will include means of attachment to windows or other surfaces, and a means to power the system. There will also be such packages with attachment and power means appropriate or relating to, but not limited to, homes, businesses and the like.

In yet another aspect, the present invention provides an adjustable frame system which can accommodate most pre-printed signs, as well as the ability to accommodate signs of various thicknesses. In addition The sign frame system has a means by which lights flash, get illuminated in a sequential manner so as to imply direction, dim, pulsate, have various hues, change the hues seen and/or the like. The sign frame system has a means of attachment and/or stand. The sign frame system has a means to supply its own power as by battery, solar and the like, and/or a power plug or adapter. In addition the sign frame system contains a means of providing a pre-recorded message, sounds, music and other such auditory means to draw attention.

In yet another aspect, the present invention provides a means of attaching lights which illuminate as well as draw attention by flashing, dimming, pulsating, illuminating in a sequence so as to imply a direction, have various hues, change the hues seen, and the like directly to a pre-printed or supplied sign. A means of attaching the sign to a surface and/or a stand is provided. A means of providing power or suitable plug and/or adapter is provided. An option of enhancing the sign by means of sounds, music, pre-recorded information and the like is available to the purchaser.

In yet another aspect of the present invention, the sign is custom made so the dimensions required for lights, sources of sounds, means of attachment, and/or stand, power source may be specific for that sign and/or signs. As such these and other required items may be permeably affixed to the sign or have the ability to be removed and utilized with other signs as to the desires of the purchaser.

### BRIEF DESCRIPTION OF THE DRAWINGS

The advantages and features of the present invention will become better understood with reference to the following more detailed description and claims taken in conjunction with the accompanying drawing, wherein like elements are identified with like symbols, and in which:

FIG. 1 is a front view of a sign frame, according to an exemplary embodiment of the present invention.

FIG. 1A is an upper perspective view of the receiving portion of the sign frame.

FIG. 2 is a bottom view of the sign frame with the magnetic supports folded in.

FIG. 2A is a bottom view of the sign frame with the magnetic supports swung out.

FIG. 3 is a front cut away view of the sign frame depicting smaller portion fitting into larger portions providing a telescopic affect.

FIG. 3A is a front view of portions of a sign frame attached to hubs which can rotate on a securing member.

FIG. 4 is a back view of the sign frame showing switches, battery compartment, speaker and adapter plugs.

FIG. 5 is a bottom front perspective view of the front and back portions of a sign frame showing attaching member and corner orifices.

FIG. 6 is a front view of a sign frame with brackets, solar panel, and battery.

### DETAILED DESCRIPTION OF THE INVENTION

The exemplary embodiments described herein detail for illustrative purposes are subject to many variations in structure and design. It should be emphasized however, that the present invention is not limited to a particular sign and sign frame, as shown and described. It is understood that various omissions and substitutions of equivalents are contemplated as circumstances may suggest or render expedient, but the description is intended to cover the application or implementation without departing from the spirit or scope of the claims of the present invention.

The terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

The present invention provides a sign frame system having an adjustable frame which encompasses a sign. The sign frame system contains lights used to illuminate the wording and image displayed as well as lights used to draw attention through means such as flashes, pulses, dimming, having various hues, changing the hues seen and/or the like. The lights are arranged in an array such that together with the sequence in which the various bulbs are illuminated will imply a directionality. The sign frame will have a power and mounting source particular to the location and intended purpose of the sign and sign frame. The sign frame system may have an audio speaker and a means of producing sounds, music, recorded messages and/or the like.

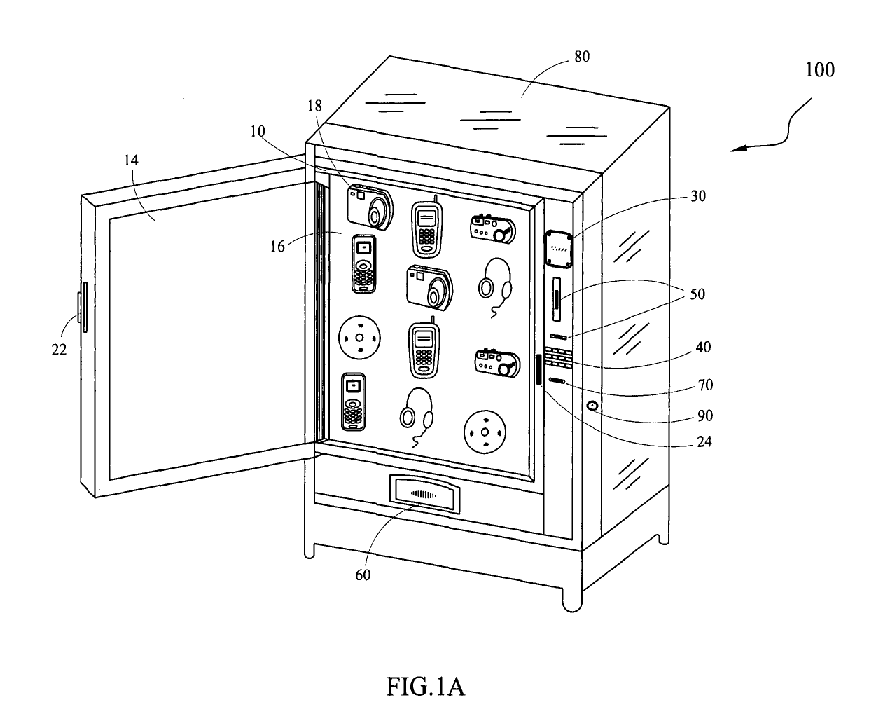

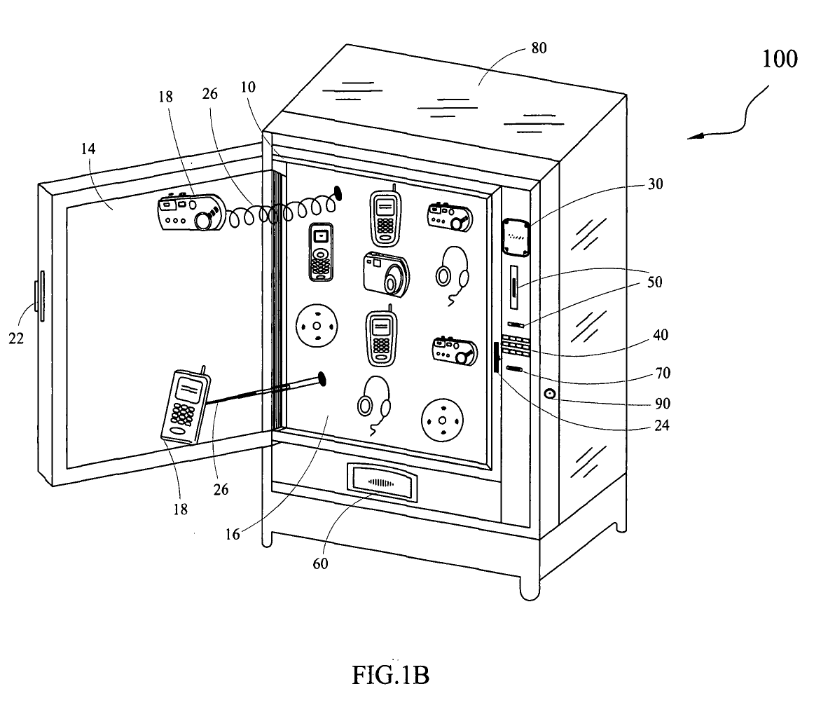

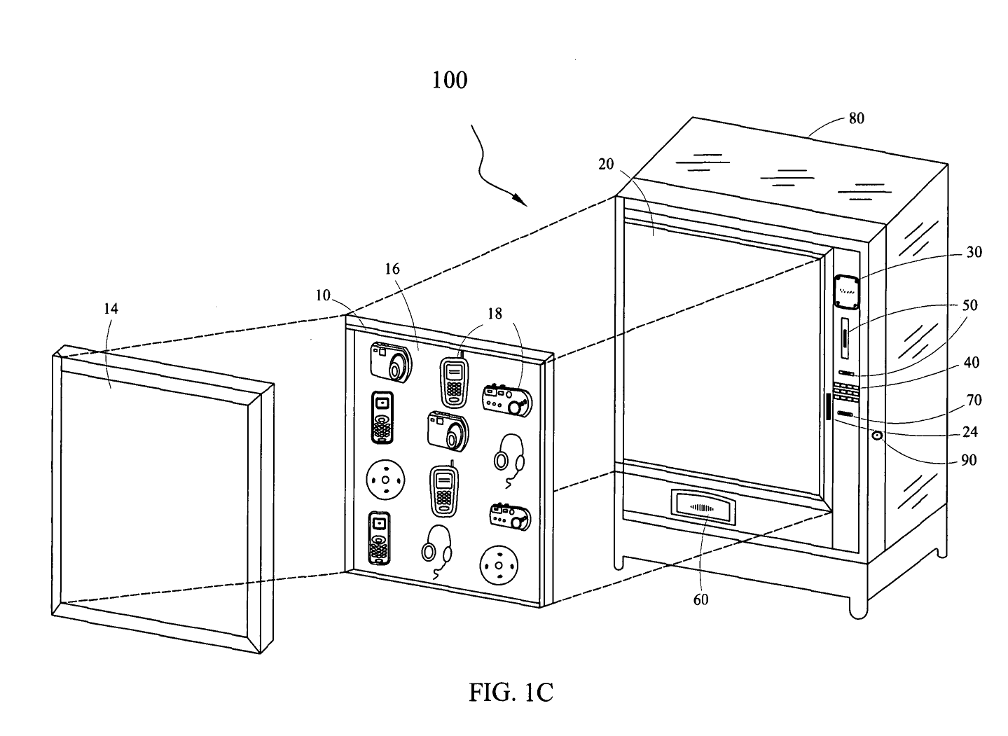

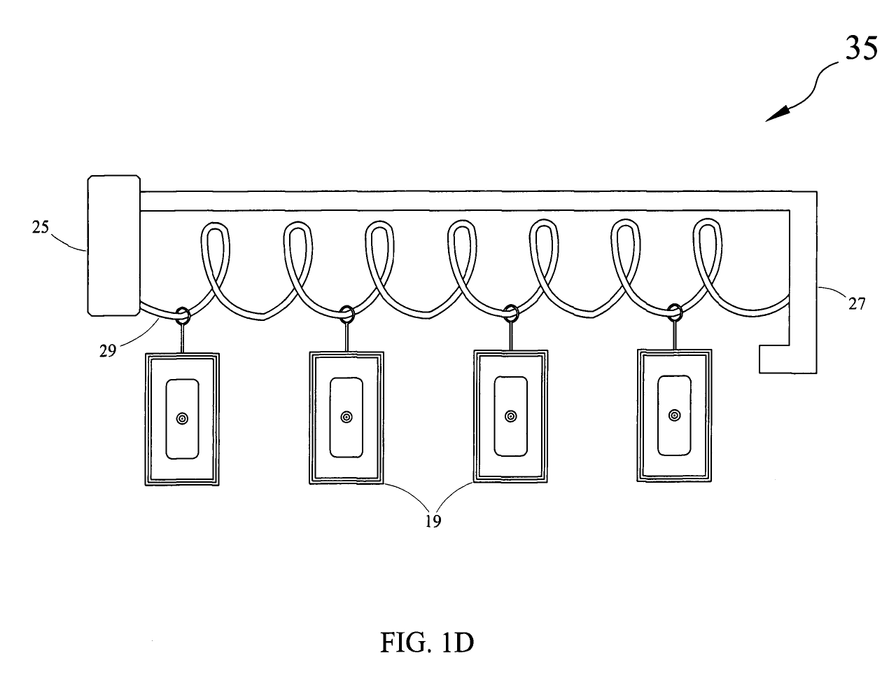

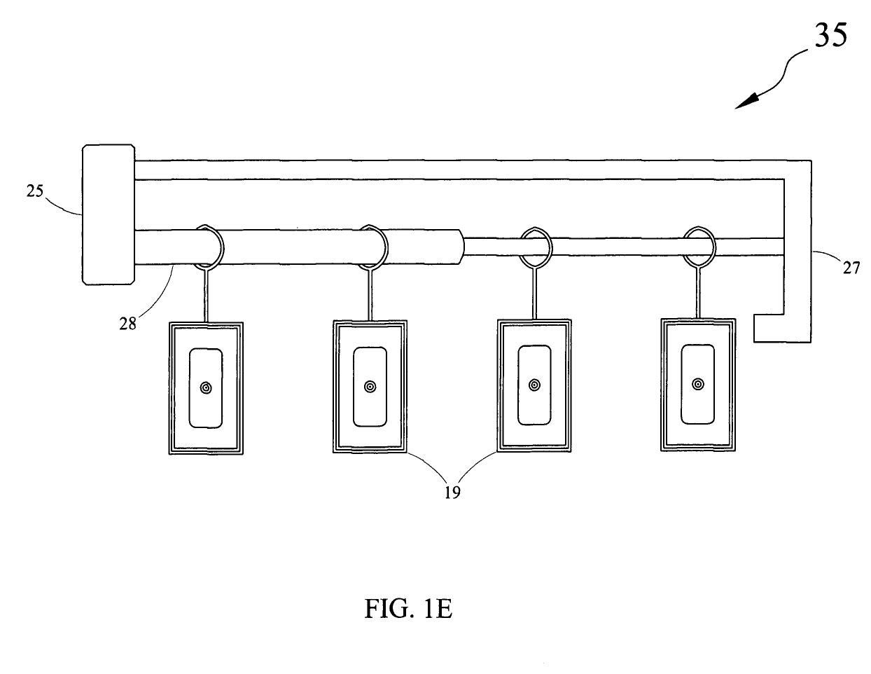

FIG. 1, illustrates a sign frame comprising receiving portions 12 and inserting portions 13. The sign frame can be constructed of plastic, rubber, elastic, aluminum, or other suitable material. The sign frame may have a slot at the top to slide the pre-printed sign down into the frame. The sign frame can have a tubular or square shape. Generally it will have three sides and an open side or trench to encompass the sign as illustrated in FIG. 1A which shows the receiving portion 12 of the sign frame and a blocking ridge 25. The inserting portion 13 has a perimeter such that it can fit and slide into the receiving portion. 12 The blocking ridge 25 keeps the inserting portion from contacting the lights and wiring of the receiving portion. The four portions thus encompass the sign. FIG. 1 illustrates a plastic or metal securing member 30 which is utilized to apply a slight pressure to the inserting portion 13 of the frame as the securing member 30 passes through the threaded orifice 31 in the receiving portion 12 of the frame. This prevents the frame portions from sliding apart. Lights not shown are spaced along the top and bottom of the frame. These lights may be incandescent, florescent or LED, come in various colors, or have a means of altering the hues seen The lights show through orifices 15 in the sign frame. These orifices are sized so a portion of the bulb can protrude through the orifice with the base of the bulb and wiring inside the sign frame. The bulbs are positioned at the corners of the receiving portions where the orifices form an array 17 to resemble an arrow. Sufficient wiring will be available to accommodate the inserting portions 13 sliding into the receiving portions 12. In addition, the light bulbs and wiring are positioned so that those of the inserting portion do not interfere with those of the receiving portion. FIG. 1 shows the orifices 15 of the receiving portion positioned lower than the orifices 15 of the inserting portion. Other positioning may also be suitable. FIG. 1, illustrates attachment to a surface with suction cups 18 at the front of the sign frame as for attachment to a window, however the suction cups 18 would be secured on the back of the sign frame for attachment to a wall, door, or other not transparent surface and/or a means for the sign to stand upright. The suction cups 18 are attached to the sign frame by securing members 19 such as rivets, screws, hooks, glue or other suitable means. Hooks, clamps, screws, or other suitable means may be utilized to attach the sign frame to a surface. Other embodiments include a sign frame system (not shown) where the receiving portions have engagement features such as key hole orifices, threaded orifices, slots, grooves and/or the like while the engaging portions have complimentary engagement features such as key hole brackets, protruding heads/studs bolts. loops, hooks and the like, which secure the portions of the frame together to a size suitable to encompass the sign.

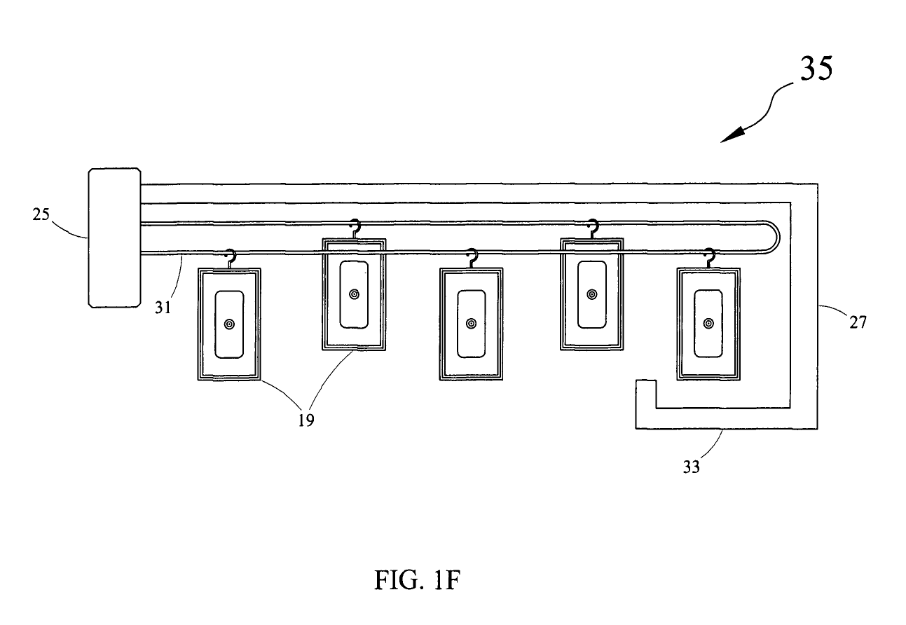

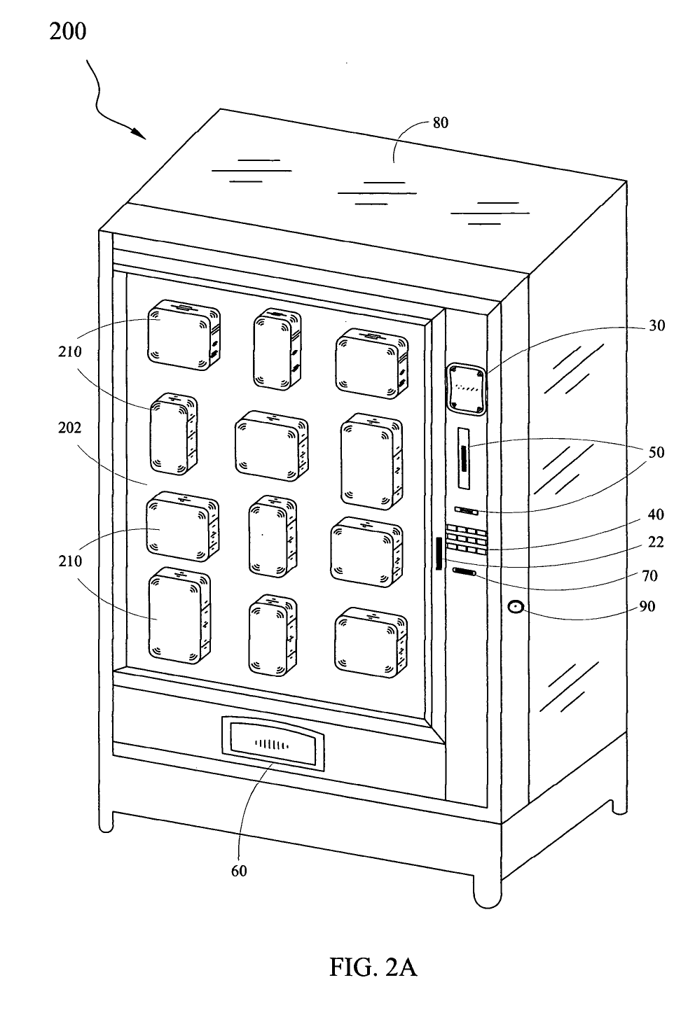

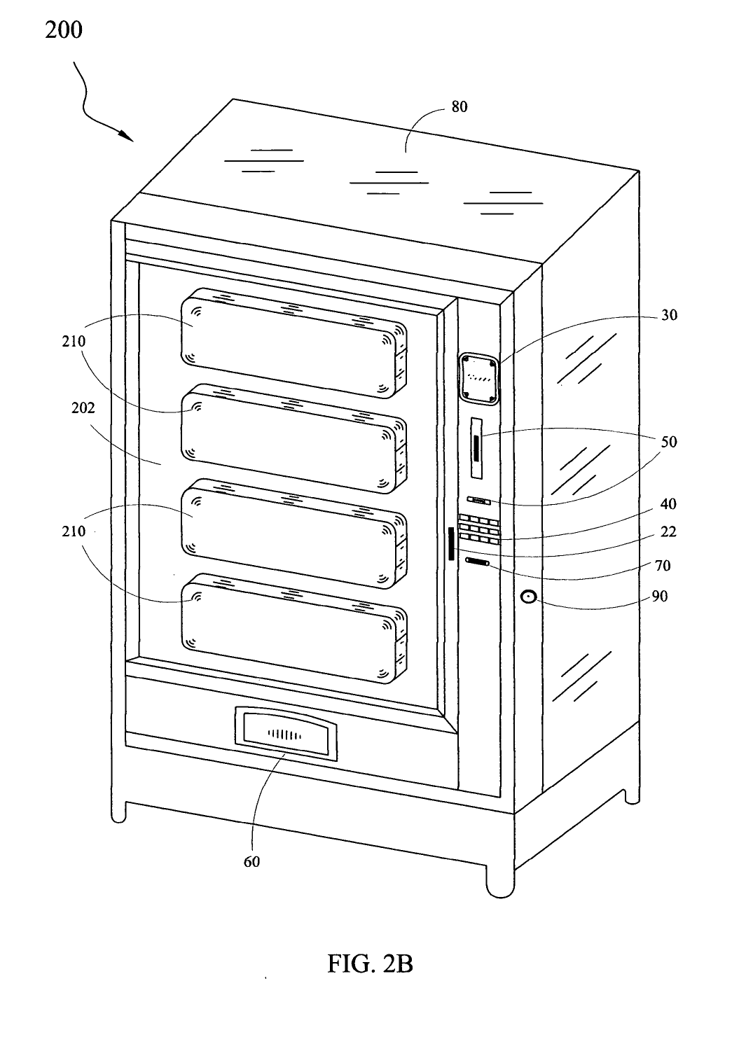

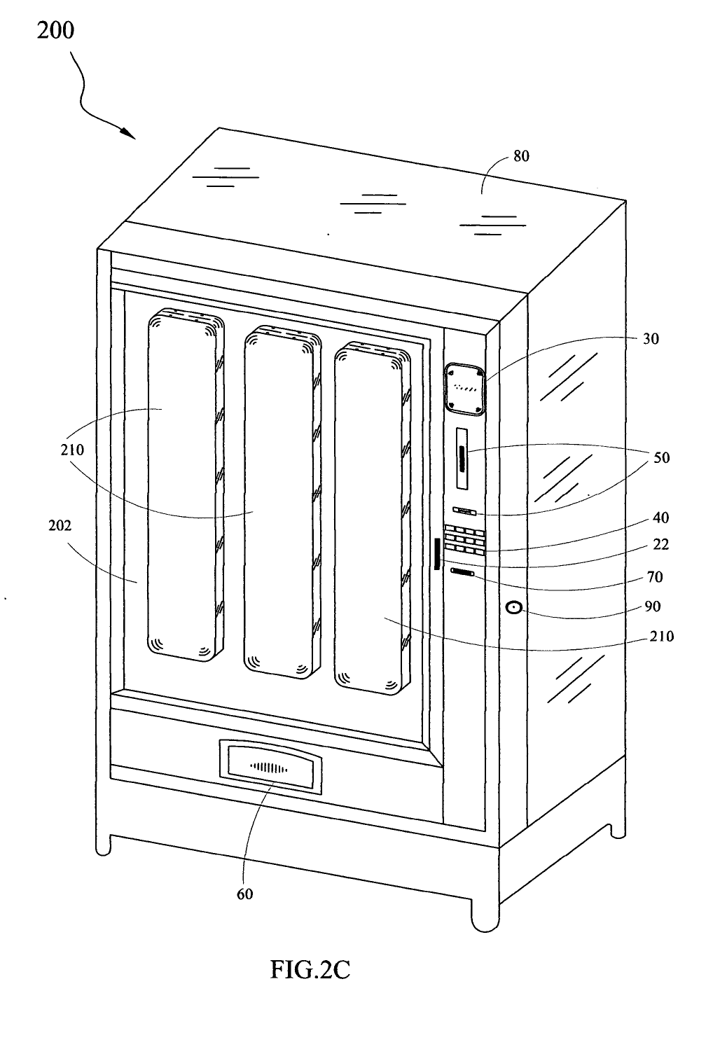

The present invention provides a sign frame with magnetic supports 10 which can be rotated so that they are in alignment with the bottom of the sign frame. FIG. 2 illustrates how the magnetic supports would be in the aligned position when the sign frame is attached to a window or to minimize packaging requirements. FIG. 2A illustrates how the magnetic supports would be rotated so that they provide a base which would attach to the metal roof of a motor vehicle to display a “SEND HELP” sign when needed. The supports 10 would be attached to the bottom of the sign frame at the receiving portion 12 and to the inserting portion 13 with a securing member 14, such as rivets, threaded bolts, screws, or other fastening device.

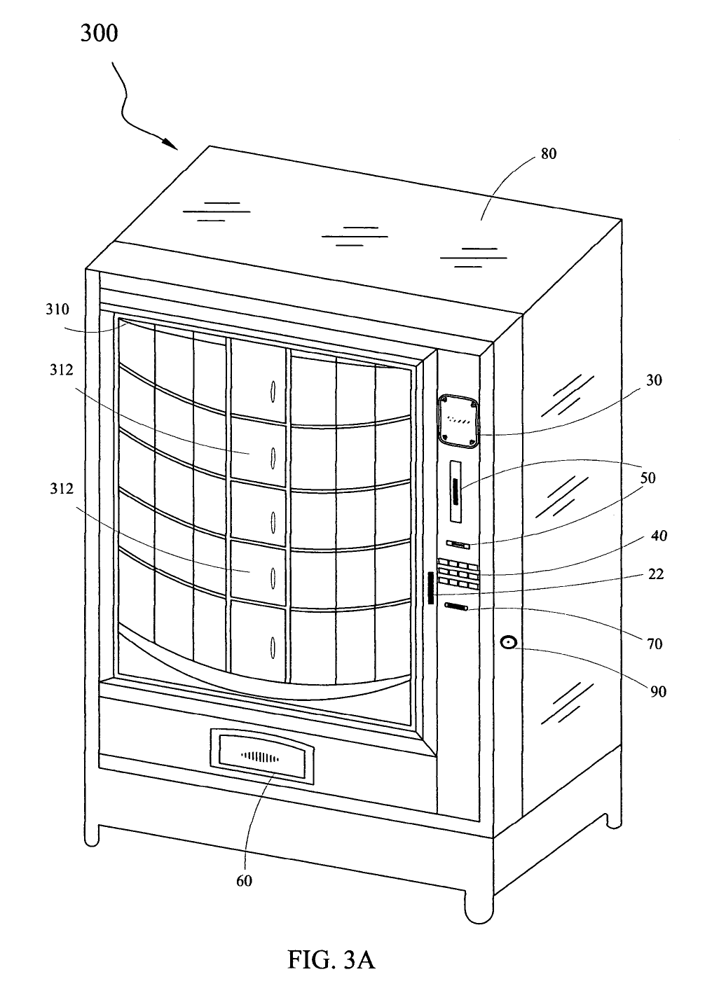

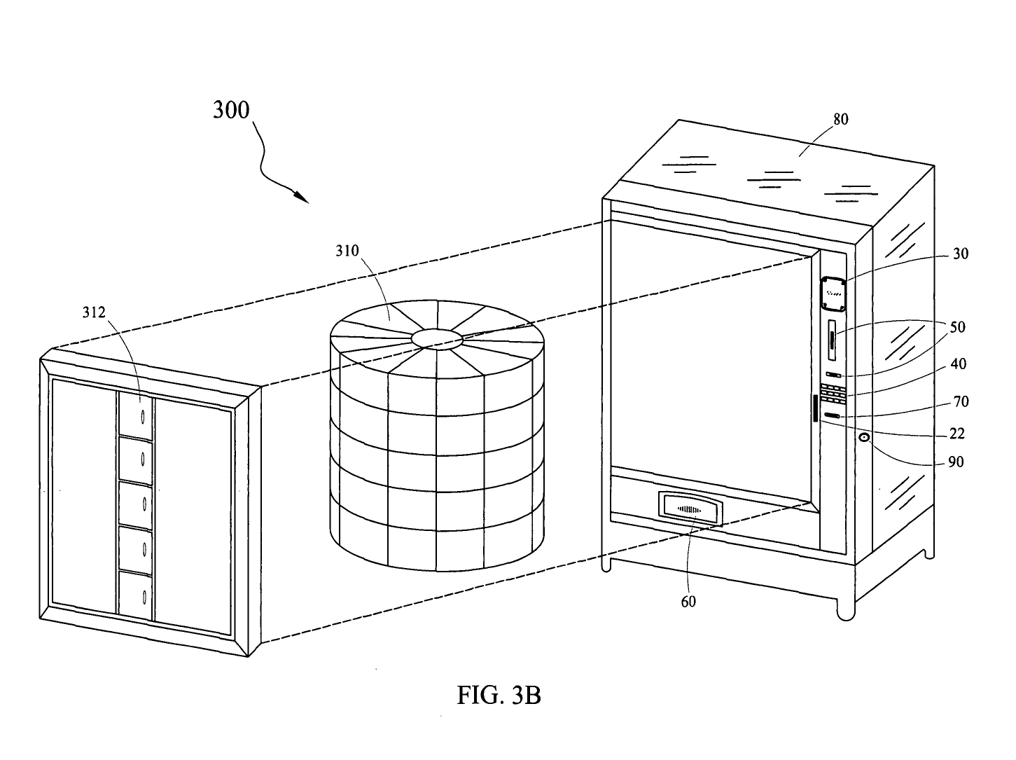

The present invention provides a sign frame system which utilizes telescopic portions 21 with a plurality of portions with various perimeters such that the smaller perimeter portions can slide into the larger perimeter portions similar to those illustrated in FIG. 1A, thus providing a sign frame which expands or contracts to encompass the sign which is displayed. There are ridges 20 on the ends of the telescopic portions which aid in keeping the portions from coming apart inadvertently. These ridges however do not completely prevent the telescopic portions from being disassembled thus allowing greater compactness. FIG. 3 illustrates such a sign frame with suction cups 18 attached at the corners but other attaching means may be utilized. FIG. 3A illustrates an outer hub 32 to which a receiving portion 12 is attached. The inserting portion 13 is attached to the inner hub 33. A securing member 34 passes through the orifice of outer hub 32, then through the orifice of inner hub 33 and is secured with a receiving member 35. The thickness of the hub and the attachment of the portions to the hub is such that the inserting portion is able to be accommodated by the receiving portion. The outer hub 16 allows the frame portion attached to it, to rotate around the securing member which thus can be utilized for polygon shaped signs. For example, by adding 4 more of the hubs with their respective portions the frame can encompass an octagon as in a stop sign. This hub allow the portions to be disassembled thus providing compactness thereby allowing a much larges sign frame to be accommodated in a smaller package. The portions encompass the sign on three sides with a trough for the sign to fit in as illustrated in FIG. 1A. Screws, bolts, tabs with complimentary features or other means can be utilized to keep the frame portions from sliding once the size is established. Attachment of the sign frame to a surface is provided by means such as suction cups, hooks, clamps, screws, and the like and/or a support to hold the sign upright.

The present invention provides a sign frame system FIG. 4, which provides a mini-speaker 40 attached to or imbedded in the sign frame. In the less expensive version the speaker will emit simple repetitive noises such as a “wolf whistle” to grab the attention of anyone who passes by. In another embodiment, a means such as a switch 41 can change the sound emitted to a different sound such as a siren sound. Other sounds, music and the like may be utilized. In a different embodiment, a micro-recorder is utilized to play back a pre-recorded message. A motion detector, timer, or other means which cause the lights and sounds to repeat their activities at predetermined time intervals. A switch or other suitable means is utilized to regulate the illumination of the lights. A three position switch 44 for example could cause the lights to flash, dim, pulsate or other like activity when in the center position. For example, moving the switch to the right turns on the light to sequentially light from left to the arrow array on the right. Moving the switch to the left turn on the light sequence to illuminate from right to the left arrow array of lights.

The present invention provides clamps, clips or other suitable means by which to attach a span of lights and wiring to the perimeter of a sign. The length of lights will be suitable for a range of limited sizes Other variation will be made available with appropriated size descriptions provided on the packaging. The lights are spaced and arranged in a manner such that a series of lights for those which span the top and bottom of the sign have an illumination sequence different from the sequence of illumination for the lights at the sides. The control of the lighting is provided by means such as a controller, with a micro-chip, transistors and/or the like contained therein. The controller can have several switches, buttons or one multi-function switch or button. As an example pushing the multi-function switch for the first time causes the lights at the top to illuminate in an alternating pattern from left to right. Pushing the switch again will cause the lights at the bottom to illuminate in an alternating pattern from right to left. Pushing the switch a third time can cause all the light to pulsate. Pushing the switch a fourth can cause the lights to dim then get brighter. Pushing the switch a fifth time shuts off the sign. These are but some of the lighting sequences available. Some lights will need to be on different strands of wire then others. These strands of wire can be braided, or other suitable means such as bands, clips clamps or the like can be utilized to keep the wires neat. These can be incorporated with the means of attaching the strand of lights to the sign and with the means to attach the sign to a surface. Suction cups with clamps, hooks with clips are some but not all of the means available. The controller can contain a micro-speaker to provide sounds or it can be a separate entity. The addition of a means of audio enhancement is a option for the purchaser. The lights will have a power source suitable for the location of usage, such as solar, battery, wall plug, cigarette lighter adapter, ac adapter and/or the like.

The present invention provides a sign and sign frame system such that pre-printed signs, sized to the windows of most motor vehicle would be provided. Signs such as “FOR SALE”, “SEND HELP” and “YARD SALE” are some but not all of the possible pre-printed signs which would be included. The sign frame provided could include but not be limited to the telescopic style, the inserting portion riding in a receiving portion presented previously or other like system. Attention to the sign would be provided by mean of lights which flash, dim, pulsate, have various hues, change the hues seen and or the like. Power to illuminate the lights and sounds would be provided by batteries 42 or rechargeable batteries, and a plug for a cigarette lighter adapter 43 as illustrated in FIG. 4. Sufficient wiring to reach from the back window to the cigarette lighter is provided. Attachment to a surface is achieved by suction cups, hooks, magnetic supports, or other such means. Means to keeps the car battery charged such as a solar panel is a possible option. A mini speaker which emits sounds, music, a mini speaker connected to a micro-recorder are possible and the like options which could be purchased. Attachment of the sign system to a surface would be provided by means such as suction cups, hooks, clamps, magnets, and the like and/or a support to hold the sign upright.

The present invention provides a sign and sign frame system suitable for the home with pre-printed signs such as “FOR SALE”, “FOR RENT” or “YARD SALE” which are some but not all of the possible signs sized to be encompassed by the sign frame. The sign frame provided may utilize but not be limited to a telescopic frame or one where the inserting portions slide in the receiving portions as illustrated in FIG. 1 and FIG. 3. Attention would be drawn by means of lights, which flash, dim, pulsate, have various hues, change the hues seen and/or the like. Power for the lights and speaker would be provided by batteries and/or an adapter plug which attaches to an AC wall outlet 12 Volt transformer. Attachment of the sign system to a surface would be provided by suction cups, hooks, screws or other such fasteners and/or have a stand.

The present invention provides a sign and sign frame system suitable for business and includes signs such as “OPEN/CLOSED”, “OFFICE”, signs listing store hours are some but not all of the possible signs sized to be encompassed by the sign frame. The sign frame provided may include but not be limited to a telescopic frame or one where the inserting portion slide in the receiving portions as illustrated in FIG. 1 and FIG. 3. Power for the lights and speaker would be provide by batteries or an adapter plug which attaches to an AC wall outlet with a 12 volt transformer. Attachment would be by suction cups, hooks, screws or other such fasteners and/or a stand.

The present invention provides a sign frame system which may utilizes but not be limited to telescopic tubes or adjustable portions where inserting portion slide in receiving portions such that the frame also has the ability to accommodate signs of various thickness as illustrated in FIG. 5. This may be accomplished by providing a separate front portion 53 secured to the back portion 54 by a securing member 50 (e.g. bolts, screws, rivets, and/or the like) which pass through orifices 51 at the corners of both front and back receiving portions and are secured with a complimentary receiving member 52 (e.g. nuts, threaded sleeves, rivet heads, and the like). Similar securing members are utilized to secure the front inserting portion 56 and back inserting portions 55 at the corners. Securing members of sufficient length and receiving members at the four corners are utilized to accommodated the thickness of the sign. The receiving portions has a perimeter greater than the inserting portions, thus providing clearance so the inserting portions does not interfere with the lights and other items which are contained therein. Other means such as but not limited to a blocking ridge may also be utilized to accomplish this. The front portions house some of the items such as the lights and their wiring while the back portions house the other items such as batteries, plugs, switches and other needed items. They are connected together electrically. The purchaser would have an option of auditory enhancement by means of a speaker with means for producing sounds, music, pre-recorded information and the like.

In another embodiment as illustrated in FIG. 6, brackets 66, or other means such as clips, hooks, clamps and the like are utilized to attach the sign frame 60 to the perimeter of the front of the sign. The lights, batteries, plugs, switches speakers, and other needed items, would be housed in the front portion of the sign frame and a back portion would not be needed. The perimeter of the receiving portions would be more pronounced than the inserting portions so as not to interfere with the light wiring and other items in the receiving portions. This would be a style beneficial for the heavier and larger signs as used in but not limited to the real estate profession. The location of these signs may be in the front lawn or on acreage of properties being sold, without a ready power source. A battery 63 and a solar panel 61 are some but not all of the possible sources of power for the lights and speaker. To prevent theft of the solar panel and battery, securing brackets 62 and 64 made of steel, or other durable material are some but not all of the means of attaching the battery and solar panel to the sign post 67 which specialty companies provide and install. The detail of the sign would be illuminated by means of lights 65 shining through cut outs in the sides of the sign frame. These light could be fluorescent, incandescent, LED and the like. While lights at the top and bottom (not shown) which flash, dim, pulsate, have various hues, change the hues seen and/or the like would draw attention. The location of the light is descriptive and not limiting. Another embodiment includes a speaker which emits sounds, music, pre-recorded information and the like. The activities of the lights and sounds would be regulated by means of, a timer, motion detector, switch, button, micro-processor micro-chip and/or the like.

In another embodiment the present invention includes the pre-printed sign which includes the lights, speaker, and plugs to connect the power sources all in the structure of the sign itself. Since the detail of many such signs is the same, for example most real estate signs simply display the words “FOR SALE” and the name of the real estate company, an expandable frame would not be required. The signs would be custom made to the dimensions specified by the real estate franchise or office. Lights would illuminate the details of the sign from the sides by means of florescent, incandescent, LED and/or the like, while lights at the top and bottom of the sign would draw attention by means of flashing, dimming, pulsating, having various hues, changing the hues seen, and/or the like. The location and types of lights is descriptive and not limiting. A option for auditory enhancement by means of sounds, music, pre-recorded information and the like would be available.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is understood that various omissions, substitutions of equivalents are contemplated as circumstances may suggest or render expedient, but is intended to cover the application or implementation without departing from the spirit or scope of the claims of the present invention.

What is claimed is:

1. A browsing and vending system, comprising:
an enclosure capable of housing a storage assembly, the storage assembly capable of storing a plurality of actual products;
a browsing cabinet engaged to a portion of a front of the enclosure, the browsing cabinet capable of storing and displaying a plurality of sample products, the sample products capable of being examined by a user on accessing the browsing cabinet for obtaining the actual products; and
a dispensing mechanism capable of dispensing actual products.

2. The browsing and vending system of claim 1, wherein a back surface of the browsing cabinet has engagement features that removably engage with complementary engagement features on the front of the enclosure.

3. The browsing and vending system of claim 2, wherein a back surface of the browsing cabinet has a plurality of suction cups to strengthen engagement of the browsing cabinet to the front of the enclosure.

4. The browsing and vending system of claim 1, further comprising a transparent door engaged to a front surface of the browsing cabinet, the transparent door covering the browsing cabinet when not in use.

5. The browsing and vending system of claim 1, wherein a remaining portion of the front of the enclosure has a display screen capable of displaying information related to the actual products.

6. The browsing and vending system of claim 1, wherein the remaining portion further has an input device with a plurality of user interface features for retrieving information related to the actual products.

7. The browsing and vending system of claim 1, wherein the remaining portion further has at least one payment slot capable of receiving payment.

8. The browsing and vending system of claim 1, wherein the remaining portion further has a printing outlet capable of dispensing an invoice for a purchased actual product.

9. The browsing and vending system of claim 1, wherein the remaining portion further has a product dispenser capable of dispensing the actual product.

10. The browsing and vending system of claim 1, wherein the actual products are selected from the group consisting of cell phones, cameras, DVDs, CDs, personal digital assistants, recharging accessories, tools, parts, and combinations comprising at least one of the foregoing.

11. The browsing and vending system of claim 1, wherein the browsing cabinet further comprises a securing mechanism for holding the sample products on to the browsing cabinet.

12. The browsing and vending system of claim 11, wherein the securing mechanism is an extendable apparatus selected from the group consisting of springs, telescopic tubes, rods, and combinations comprising at least one of the foregoing.

13. The browsing and vending system of claim 1, wherein the dispensing mechanism is an extendable apparatus selected from the group consisting of springs, telescopic tubes, carousel, rods, and combinations comprising at least one of the forgoing.

14. The browsing and vending system of claim 1, wherein the dispensing mechanism works in conjunction with a securing port to for providing access to the actual products.

15. A browsing and vending system, comprising:
a storage assembly capable of storing a plurality of actual products;
a display section disposed on a front side of the storage assembly, the display section capable of storing and displaying a plurality of display products;
an enclosure capable of housing the storage assembly and the display section; and
an authentication mechanism capable of authenticating a user prior to accessing the display section,
thereby enabling access of the display section for examination of the display products by the user for obtaining the actual products.

16. The browsing and vending system of claim 15, wherein the display products are actual products.

17. The browsing and vending system of claim 15, wherein the display section is divided into a plurality of display compartments, and wherein each display compartment is capable of displaying at least one display product.

18. The browsing and vending system of claim 17, wherein the display compartments are organized in a plurality of rows, wherein each row has similar display products.

19. The browsing and vending system of claim 17, wherein the display compartments are organized in a plurality of columns, wherein each column has similar display products.

20. The browsing and vending system of claim 15, further comprising a sliding door covering the display section, the sliding door capable of being unlocked upon authentication of the user, thereby enabling access of the display section for examination of the display products.

21. The browsing and vending system of claim 15, wherein the actual products are selected from the group consisting of cell phones, cameras, DVDs, CDs, personal digital assistants, tools, parts, and combinations comprising at least one of the foregoing.

22. The browsing and vending system of claim 15, further comprising a scanner capable of reading bar codes and RFID tags for allowing the user to examine and return display products to the browsing and vending system without being charged.

23. A browsing cabinet, comprising:
a storage for storing a plurality of sample products;
a display for displaying the sample products; and
a coupling mechanism capable of attaching the browsing cabinet to a vending machine, the vending machine storing a plurality of actual products;
wherein the sample products are capable of being examined by a user on accessing the browsing cabinet for obtaining the actual products.

24. A vending machine, comprising:
a storage assembly capable of storing a plurality of actual products;
a rotating carousel concentrically circumscribing the storage assembly, the rotating carousel having a plurality of display compartments capable of storing and displaying a plurality of display products, the rotating carousel capable of being rotated to access the display compartments;
an enclosure capable of housing the storage assembly and the rotating carousel; and
an authentication mechanism capable of authenticating a user prior to accessing the display section,
thereby enabling access of the display compartment for examination of the display products by the user for obtaining the actual products.
